(19) United States
(12) Patent Application Publication
(10) Pub. No.: US 2023/0213055 A1
(43) Pub. Date: Jul. 6, 2023

(54) NON-PROJECTING BLIND RIVET NUT OR NON-PROJECTING BLIND RIVET STUD

(71) Applicant: HONSEL UMFORMTECHNIK GMBH, Froendenberg (DE)

(72) Inventor: THOMAS KAMRAD, Dortmund (DE)

(73) Assignee: HONSEL UMFORMTECHNIK GMBH, Froendenberg (DE)

(21) Appl. No.: 18/087,839

(22) Filed: Dec. 23, 2022

(30) Foreign Application Priority Data
Jan. 4, 2022 (DE) 10 2022 100 104.0

(51) Int. Cl. F16B 37/06

(52) U.S. Cl. CPC F16B 37/067

(57) ABSTRACT

A blind rivet nut for incorporating a thread in a clearance of a workpiece and/or for connecting two workpieces. The blind rivet nut includes a setting region, a thread region having an internal thread in portions of the thread region, and a compression region arranged between the thread region and the setting region. The compression region forms a closing bead when a first force acting on the compression region is exceeded. The setting region has an axial portion which faces the compression region and a free axial portion which faces away from the compression region and from the thread region. When a second force acting on the setting region is exceeded, the free axial portion which faces away from the thread region is enlarged at least in a radial direction with respect to an external dimension of the setting region.

### CROSS REFERENCE TO PRIOR APPLICATIONS

Priority is claimed to German Patent Application No. DE 10 2022 100 104.0, filed Jan. 4, 2022. The entire disclosure of said application is incorporated by reference herein.

### FIELD

The present invention relates to the technical field of setting blind rivet nuts or blind rivet studs, wherein the blind rivet studs are also referred to as blind rivet screws. The present invention in particular relates to a blind rivet nut or to a blind rivet stud that enables a non-projecting setting into a clearance of a workpiece. The present invention also relates to a suitable blind rivet nut setting tool or blind rivet stud setting tool for setting such a blind rivet nut or such a blind rivet stud, to a method, and to an assembly system for setting the blind rivet nut.

### BACKGROUND

Blind rivet nuts which, when the blind rivets are incorporated in a smooth bore of a workpiece via the countersunk head thereof, for example, upon setting have a projection, are known from the prior art. Such a blind rivet nut is described, for example, in DE 10 2013 214 247 A1. Such a projection, which configures an interfering edge on the workpiece, is undesirable for many applications.

The prior art describes successfully avoiding such an interfering edge when a corresponding countersinking about the bore in the workpiece is provided prior to setting the blind rivet nut, wherein the countersunk head of the blind rivet nut is completely incorporated in the countersinking.

This provision of countersinking is disadvantageous as an additional effort is always required, and is disadvantageous above all for reasons of stability in the case of thin workpieces.

### SUMMARY

An aspect of the present invention is to provide a blind rivet nut, a blind rivet nut setting tool for setting such a blind rivet nut, a method, and an assembly system for setting the blind rivet nut, so as to make a non-projecting or an almost non-projecting setting of the blind rivet nut possible, and to thereby at least partially eliminate the disadvantages of the prior art set forth above. An aspect of the present invention is also to provide a blind rivet stud, a blind rivet stud setting tool for setting such a blind rivet stud, a method, and an assembly system for setting the blind rivet stud, so as to make possible a non-projecting or an almost non-projecting setting of the blind rivet stud and to thereby at least partially eliminate the disadvantages of the prior set forth above.

In an embodiment, the present invention provides a blind rivet nut for incorporating a thread in a clearance of a workpiece and/or for connecting two workpieces. The blind rivet nut includes a setting region, a thread region which comprises an internal thread at least in portions of the thread region, and a compression region arranged between the thread region and the setting region. The compression region is configured so that, when a first force acting on the compression region is exceeded, the compression region forms a closing bead. The setting region comprises an axial portion which faces the compression region and a free axial portion which faces away from the compression region and from the thread region. The setting region, on the free axial portion which faces away from the thread region, is configured so that, with respect to an external dimension of the setting region, the setting region is enlarged at least in a radial direction when a second force acting on the setting region is exceeded.

### BRIEF DESCRIPTION OF THE DRAWINGS

The present invention is described in greater detail below on the basis of embodiments and of the drawings in which:

FIG. 1 shows a lateral view of the assembly system according to the present invention for setting a blind rivet nut, prior to spinning on the blind rivet nut;

FIG. 2 shows a lateral view of the assembly system according to the present invention for setting a blind rivet nut, after spinning on the blind rivet nut;

FIG. 3 shows the blind rivet nut according to the present invention in a set state in a workpiece, as a cross-sectional view;

FIG. 4 shows an enlarged illustration of the setting region of the blind rivet nut from FIG. 3, which generates a friction-fit and/or form-fit with the workpiece;

FIG. 5 shows a lateral view of the assembly system according to the present invention for setting a blind rivet stud; and

FIG. 6 shows the blind rivet stud according to the present invention in a set state in a workpiece, as a cross-sectional view.

### DETAILED DESCRIPTION

The present invention provides a blind rivet nut for incorporating a thread in a clearance of a workpiece and/or for connecting two workpieces, wherein the blind rivet nut comprises:
a setting region, wherein the setting region is the region of the blind rivet nut via which the blind rivet nut sits in the component;
a thread region, wherein the thread region has an internal thread at least in portions; and
a compression region, wherein the compression region is provided between the thread region and the setting region, and when a first force acting on the compression region is exceeded is configured to form a closing bead, and wherein the setting region has an axial portion facing the compression region, and a free axial portion facing away from the compression region. Since the blind rivet nut can, for example, be integrally configured, the compression region in this case transitions seamlessly to the axial portion of the setting region that faces the compression region. The blind rivet nut has an inner cavity so that a thread pin can, for example, be introduced through the free axial portion into the interior of the blind rivet nut.

A core concept of the present invention is that the setting region on the free axial portion thereof facing away from the thread region, when a second force acting on the setting region is exceeded, in terms of the external dimensions thereof, is able to be enlarged at least in a radial direction. The first force and the second force can be caused by a single lifting movement of a blind rivet nut setting tool, and can in particular also be of substantially identical size. The first force and the second force would in this case be for all extents and purposes a “single force”.

The blind rivet nut according to the present invention differs from a blind rivet nut from the prior art substantially in that the blind rivet nut according to the present invention does not have a setting head which, when incorporated in a clearance of a smooth surface, causes an interfering edge, because the setting head via the interfering edge/setting head conventionally fixes the blind rivet nut in an axial direction on the surface. As a result of the free axial portion of the setting region, where the setting head is located in conventional blind rivet nuts, being able to be enlarged by exerting the force, the blind rivet nut upon complete incorporation in a clearance of a workpiece can thus be deformed so that a friction-fit and/or form-fit with the workpiece can be generated. The blind rivet nut can thereby be fixed axially on, or rather in, the workpiece in a non-projecting or in an almost non-projecting manner. The force here exerted should, for example, also be sufficiently high in order for the workpiece to be deformed because a form-fit generally offers better axial fixing than a friction-fit. The external dimensions of the blind rivet nut are smaller than the internal dimensions of the clearance so that the blind rivet nut can be incorporated in the clearance with a small amount of play. The clearance can, for example, be in the shape of a hole. The clearance can in particular be a bore. It is also generally possible for the first force and the second force to be of an identical size so that the closing bead as well as the deformation of the free axial portion can be generated as a result.

It is in principle sufficient for the enlargement to be generated along a single radial direction. The enlargement can, for example, be performed along a straight line. Stability is increased when the enlargement can, for example, be generated symmetrically along a plurality of directions, in particular when the free axial portion is enlarged in a circular manner. This circular enlargement in three-dimensional terms can, for example, correspond to a conical enlargement.

The blind rivet nut can, for example, be made of steel, high-grade steel, copper, copper alloy and/or aluminum. In an embodiment, the blind rivet nut is integrally configured to have a homogeneous material composition. This advantageously makes possible an efficient production of the blind rivet nut.

The present invention also provides a blind rivet stud for incorporating a thread in a clearance of a workpiece and/or for connecting two workpieces, wherein the blind rivet stud comprises:
a setting region;
a screw region, wherein a screw having an external thread is fixed in the screw region; the screw here in particular exits the setting region so that the external thread of the screw can be spun on a mouthpiece of a setting apparatus and/or that upon setting the blind rivet stud a nut for bracing two workpieces can be screwed onto the external thread; and
a compression region, wherein the compression region is provided between the screw region and the setting region and, when a first force acting on the compression region is exceeded, is configured to form a closing bead, wherein the setting region has an axial portion facing the compression region, and a free axial portion facing away from the compression region,
wherein the setting region on the free axial portion thereof facing away from the screw region, when a second force acting on the setting region is exceeded, in terms of the external dimensions thereof is able to be enlarged at least in a radial direction.

The technical effects and advantages of such a blind rivet stud correspond to those that have been described above in the context of the blind rivet nut. The blind rivet stud may also be referred to as a blind rivet screw.

Such blind rivet studs according to the present invention, after setting, have a projection of 0 mm in the components or in the workpieces. Components or workpieces can thereby be screwed to one another completely without interfering edges.

As a result of the shape and embodiment of the sleeve of the blind rivet stud without a head of any dimensions, the sleeve, while utilizing a mouthpiece with an appendage, can be incorporated in a non-projecting manner in a component. The sleeve of the blind rivet stud can have different shapes (round, hexagonal, etc.); knurls, grooves, appendages, etc., in the shank region are also possible.

Advantageous design embodiments, in particular the technical effects thereof, will be described hereunder, in most instances in the context with the blind rivet nut. As is clear to the person skilled in the art, the technical effects likewise apply to the blind rivet stud according to the present invention.

In a design embodiment of the blind rivet nut, the portion of the setting region that faces away from the thread region can, for example, be substantially free of projections. In a design embodiment of the blind rivet stud, the portion of the setting region that faces away from the screw region can, for example, be substantially free of projections.

This has the advantage that the blind rivet nut can be readily incorporated in the clearance. Further advantages include the following: if the projection were located where the setting head is in conventional blind rivet nuts, the risk would exist that an interfering edge is again created when the setting region is being enlarged because the projection would be able to slide onto the surface of the workpiece when the radial force is being exerted. However, if the projection were disposed further in the direction of the thread region of the blind rivet nut, this would inevitably increase the spacing of the enlargeable setting region from the workpiece so that the setting region would disadvantageously have to be more intensely deformed. Comparatively small unevennesses caused by the material are not referred to as projections within the context of this text.

In a design embodiment of the present invention, an external shape of the blind rivet nut or of the blind rivet stud can, for example, be at least largely cylindrical; the external shape configuring in particular a straight extent parallel to a rotation axis in terms of an elongate extent of the blind rivet nut or of the blind rivet stud. A further possibility for describing the external shape of the blind rivet nut or of the blind rivet stud is that the external shape is configured like a sleeve.

This offers the advantage that the blind rivet nut is particularly easy to produce and, when incorporated in the clearance of the workpiece, has a uniform spacing from an internal region of the workpiece. In order to enable the blind rivet nut to be more easily incorporated in the workpiece, the free thread portion can be slightly bent in the direction of the longitudinal axis of the blind rivet nut. This bent region can, for example, not be longer than 10% of the length of the blind rivet nut. This makes it possible that the blind rivet nut can more easily be incorporated in the clearance, and that the blind rivet nut across the largest part of the longitudinal region thereof nevertheless has a uniform spacing from the internal region of the workpiece.

In a design embodiment of the present invention, the enlargement in the radial direction in terms of the external dimension can, for example, be more than 0.1%, for example, 0.5%, for example, 1%.

The choice as to the extent to which the external dimension is to be able to be enlarged will also depend on how high potential axial forces are in relation to which the blind rivet nut has to be able to be fixed. It moreover applies that the greater the enlargement, the more the ratio of friction-fit component to form-fit component shifts in the direction of the form-fit component. The smaller the enlargement, the less force must be exerted on the blind rivet nut when the latter is being incorporated. The blind rivet nut can accordingly also be more flexibly designed in terms of material technology. It has been demonstrated that an enlargement in terms of the external dimension of more than 0.1% is already sufficient for providing sufficient axial fixing of the blind rivet nut in a multiplicity of application fields. If a friction-fit is already sufficient in specific applications, the enlargement may also be less than 0.1%.

The first force and the second force can, for example, be of dissimilar sizes.

This makes it possible for the form-fit and/or the friction-fit to be generated also in cases where a higher force is required in order for the workpiece to be deformed than in order for the closing bead of the blind rivet nut to be generated. For this purpose, the blind rivet nut setting tool described in more detail hereunder can, for example, have two different modes, wherein the closing bead is generated via the first force using the first mode, and the setting region on the free axial portion is enlarged via the second force using the second mode.

In an embodiment, the thread region or the screw region can, for example, be configured from a high-tensile material, wherein the thread region or the screw region is not able to be deformed.

As opposed to conventional blind rivet nuts, the second force must be sufficient for deforming the free axial portion of the setting region as well as the workpiece. At the same time, however, the thread region should remain intact should the blind rivet nut in a later state also provide a thread in the clearance. These characteristics thus advantageously make it possible that the free axial portion of the setting region as well as the workpiece are deformed while at the same time the thread region remains intact. It is in principle possible in this context that the setting region and the thread region are produced using dissimilar materials, however, the setting region and the thread region can, for example, be produced from the same materials because this is more efficient in terms of production, wherein the setting region and the thread region in the production process are at least at times differently treated, as a result of which the thread region is more resistant, i.e., harder, in relation to deformations than the setting region. If the blind rivet nut is intended to only connect two workpieces to one another, which is also possible in principle, it is not mandatory for the thread region to remain intact.

The present invention also provides a blind rivet nut setting tool for setting the blind rivet nut described above, wherein the blind rivet nut setting tool comprises:
a thread pin having at least one threaded portion, wherein the blind rivet nut is able to be spun on via the thread pin;
a mouthpiece, wherein the mouthpiece surrounds the thread pin;
a rotation module which has a first operative connection to the thread pin, wherein a rotating movement for spinning on and/or off the blind rivet nut is able to be transmitted into the thread pin via the rotation module; and
a lifting module which has a second operative connection to the thread pin, wherein at least one lifting movement for compressing the blind rivet nut is able to be transmitted into the thread pin via the lifting module, wherein the mouthpiece forms a counter bearing for the blind rivet nut; the lifting module can in particular here induce the afore-mentioned first and/or second force.

It is here a substantial feature that the mouthpiece has a detent portion for the blind rivet nut, wherein the detent portion has a detent face which decreases in size in the direction of the thread portion.

The detent portion of the mouthpiece here forms the counter bearing which is required in order for the blind rivet nut to be deformed when the thread pin, as a result of the lifting movement, is retracted through the mouthpiece. The setting region of the blind rivet nut is in this case pressed against the mouthpiece and can be deformed. The shape of the detent face according to the present invention makes it possible that the free axial setting region of the blind rivet nut described above is enlarged, and the closing bead of the blind rivet nut is also generated, potentially in an upstream or downstream process. The further the lifting module thus retracts the thread pin, the deeper the detent face is pressed into the free axial setting region of the blind rivet nut, thus enlarging the latter. As has been described above, a form-fit and/or friction-fit with the clearance of the workpiece is generated as a result of this enlarged free axial setting region. The threaded portion of the thread pin is, for example, typically designed as a counter thread to the internal thread of the blind rivet nut.

The present invention also provides a blind rivet stud setting tool for setting a blind rivet stud described above, wherein the blind rivet stud setting tool comprises:
a mouthpiece, wherein the mouthpiece has an internal thread for spinning on a screw of the blind rivet stud;
a rotation module, wherein a rotating movement for spinning on and/or off the blind rivet stud is able to be transmitted to the mouthpiece via the rotation module; and
a lifting module, wherein at least one lifting movement for compressing the blind rivet stud is able to be transmitted into the mouthpiece via the lifting module, wherein the mouthpiece forms a counter bearing for the blind rivet stud,
wherein the mouthpiece has a detent portion for the blind rivet stud, and wherein the detent portion has a detent face which decreases in size in the direction of the blind rivet stud that is able to be spun on.

The advantages and technical effects of the blind rivet stud setting tool correspond substantially to the blind rivet nut setting tool described above.

Advantageous design embodiments, in particular the technical effects thereof, will be described hereunder in most instances in the context of the blind rivet nut setting tool. As is clear to the person skilled in the art, the technical effects also apply to the blind rivet stud setting tool according to the present invention.

In an embodiment of the present invention, the detent face can, for example, be enlarged continuously or by way of different angles.

If the detent face is continuously enlarged, this has the advantage that the detent face is generally easier to produce, wherein a detent face having different angles is suitable for flexibly determining how high the force is that the detent face exerts on the blind rivet nut, depending on the retraction depth of the thread pin. The material of the detent face can, for example, be chosen so that the material is not deformed by the setting process. The material of the detent face should thus in particular be sufficiently large so as not to be deformed by the second force.

The detent face of the blind rivet nut setting tool can, for example, have a region facing the threaded portion that is smaller than an internal region of the free axial portion of the setting region of the blind rivet nut, and the detent face has a region facing away from the thread portion that can, for example, be larger than the internal region of the free axial portion of the setting region of the blind rivet nut.

It is advantageously made possible as a result that the detent face can be readily incorporated in the free axial portion of the setting region of the blind rivet nut, and enlarges the latter when the thread pin is continually retracted in the direction of the mouthpiece.

In a design embodiment of the present invention, the detent face can, for example, be configured to be conical.

Such a detent face is easy to produce and also advantageously leads to a uniform force being exerted on the blind rivet nut and thereby also indirectly on the workpiece. Such a uniform exertion of force is generally particularly efficient and likewise leads to uniform axial fixing. Such uniform characteristics are generally advantageous because predetermined breaking points or the like are thereby prevented.

The present invention also provides for a method for setting a blind rivet nut in a clearance of a workpiece while using the blind rivet nut described above and the blind rivet nut setting tool described above, the method comprising the following steps:
placing the blind rivet nut on the thread pin of the blind rivet nut setting tool;
spinning on the blind rivet nut up to the detent face of the mouthpiece;
completely incorporating the free axial setting region of the blind rivet nut in the clearance of the workpiece; and
compressing the blind rivet nut by a lifting movement of the blind rivet nut setting tool in the direction of the mouthpiece, wherein the free axial setting region is enlarged by the lifting movement and brings about a form-fit and/or a friction-fit with the workpiece, and wherein the compression region forms a closing bead.

As a result of the free axial setting region being completely incorporated in the clearance of the workpiece, it is possible for the blind rivet nut to be set without an interfering edge on the corresponding surface of the workpiece being generated. This is made possible in that, upon complete incorporation, the axial fixing of the blind rivet nut is implemented by the form-fit and/or friction-fit, the latter being generated when the free axial setting region as a result of the enlargement local bearing stress is brought to bear on the workpiece.

The present invention also provides for a method for setting a blind rivet stud in a clearance of a workpiece while using a blind rivet stud described above and a blind rivet stud setting tool described above, the method comprising the following steps:
spinning on the blind rivet stud up to the detent face of the mouthpiece;
completely incorporating the free axial setting region of the blind rivet nut in the clearance of the workpiece; and
compressing the blind rivet stud by a lifting movement of the blind rivet stud setting tool in the direction counter to the clearance, wherein the free axial setting region is enlarged by the lifting movement and brings about a form-fit and/or a friction-fit with the workpiece, and wherein the compression region forms a closing bead.

By using the mouthpiece having the appendage, thus the detent face, the shank of the sleeve of the blind rivet stud is pushed open outward in the setting process, and local bearing stress is brought to bear in the bore of the component. The contour of the appendage on the mouthpiece can here have different shapes. The blind rivet stud is pulled smoothly up to the upper side of the component as a result of the setting procedure. The closing bead is formed as in a standard blind rivet stud. The blind rivet stud is set in a non-projecting manner in the component and thus has a projection of 0 mm. No interfering edge is, for example, created. An additional process of “countersinking” the bore is not required as is the case, for example, in countersunk head embodiments of the blind rivet studs.

The present invention also provides for an assembly system for setting a blind rivet nut or a blind rivet stud, said assembly system comprising:
the blind rivet nut described above, or the blind rivet stud described above; and
the blind rivet nut setting tool described above or the blind rivet stud setting tool described above,
wherein the assembly system is specified for carrying out the method described above.

In a design embodiment, the assembly system can, for example, additionally comprise a workpiece having the clearance into which the blind rivet nut is incorporated as described in the method.

Exemplary embodiments of the present invention will be explained below under reference to the drawings.

Numerous features of the present invention will be explained in detail hereunder via embodiments. The present disclosure is thereby not limited to the combinations of features specifically mentioned. The features here mentioned can much rather be combined in an arbitrary manner so as to form embodiments according to the present invention unless expressly precluded hereunder.

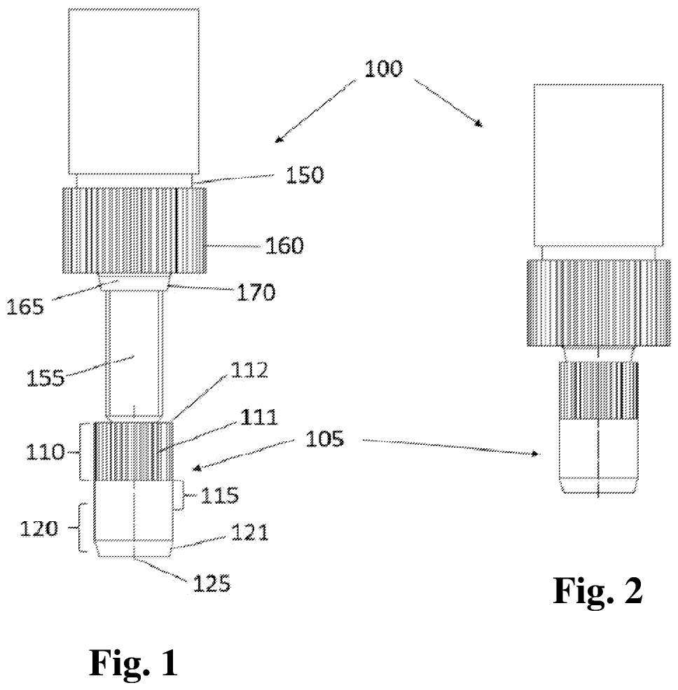

FIG. 1 shows a lateral view of the assembly system 100 according to the present invention for setting a blind rivet nut 105 prior to spinning on the blind rivet nut 105 in the blind rivet nut setting tool 150. The blind rivet nut setting tool 150 is not shown completely in the illustration according to FIG. 1 because a corresponding rotation module and lifting module associated with the blind rivet nut setting tool 150 are in particular known to the person skilled in the art. Accordingly, only those component parts of the blind rivet nut setting tool 150 that are relevant to the present invention, or advantageously refine the present invention, are respectively shown.

The blind rivet nut setting tool 150 has a thread pin 155 which at least in portions, on the portion facing away from the blind rivet nut setting tool 150, has a thread (which is not shown). The thread pin 155 can, however, also be configured as a thread along the entire region thereof shown in FIG. 1. The thread pin 155 runs coaxially through a mouthpiece 160. The thread pin 155, in particular by the lifting module (which is not shown), can be axially displaced through the mouthpiece 160.

The mouthpiece 160 has a detent portion 165, wherein the detent portion 165 has a detent face 170 which decreases in size in the direction of the free end of the thread pin 155. This may also be worded so that the detent face by way of the larger face thereof faces the mouthpiece 160, and the smaller face thereof faces away from the mouthpiece 160. The detent portion 165 in particular has a conical shape, the larger face thereof bearing on the mouthpiece 160, or being able to be connected to the latter.

The blind rivet nut 105 in the lateral view displays the shape of a sleeve. The thread pin 155 can coaxially penetrate the blind rivet nut 105 and in particular engage in an internal thread (not shown in the lateral view) of the blind rivet nut 105, or spin on the internal thread, respectively.

The blind rivet nut 105 has a setting region 110, a compression region 115, and a thread region 120. The setting region 110, at least on the free axial portion 112 thereof facing away from the thread region 120, when a second force acting on the setting region 110 is exceeded, in terms of the external dimension thereof is able to be enlarged in the radial direction. To this end, the second force can in particular act in a radially outward manner. In principle, dimensions of the blind rivet nut 105 can be flexibly designed and accordingly be adapted so as to depend on the clearance of the workpiece. When the first force is being exerted, the compression region 115 is deformed so as to form a closing bead. The thread region 120 comprises the internal thread which is not shown in FIG. 1 and is configured as a counter thread to the thread of the thread pin 155. The thread region on the free end thereof has a conically tapered region 121. The conically tapered region 121 makes it possible that the blind rivet nut 105 can be more easily incorporated in a clearance. Self-centering of the blind rivet nut 105 in the clearance of the workpiece can be initiated by the conically tapered region 121. The compression region 115 should extend into the knurled region of the setting region to the extent of approximately ⅓.

Different shapes which the blind rivet nut 105 can assume include, for example, a round cross section or a hexagonal cross section in terms of the longitudinal axis 125 through the blind rivet nut 105. The external surface of the blind rivet nut 105 of the setting region 110 can have a fluting 111. The fluting 111 provides that the blind rivet nut 105 is secured in relation to the twisting in the clearance of the workpiece.

FIG. 2 shows the lateral view of the assembly system 100 according to the present invention for setting a blind rivet nut 105 after spinning on the blind rivet nut 105 on the thread pin 155. FIG. 2 shows that the free axial portion 112 after the spinning on comes to bear on the detent face 170. If the lifting module now is further retracted into the mouthpiece 160, the detent face 170 exerts on the free axial portion 112 a force having a radial component, the latter leading to an enlargement of the dimensions of the free axial portion 112. In order for this to be clarified and emphasized once again, the radial force is exerted on an internal side of the blind rivet nut 105. In other words, it could be said that the blind rivet nut 105 is pushed apart on the upper setting region 110 thereof.

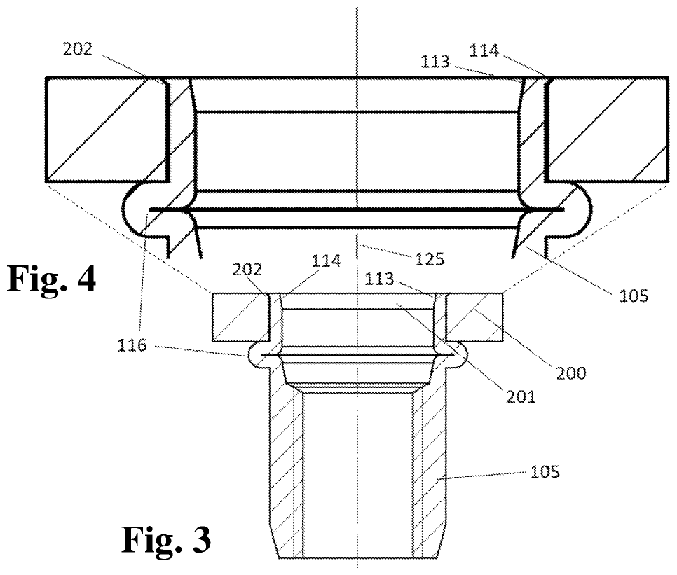

FIG. 3 shows the blind rivet nut 105 in a set state in a workpiece 200 as a cross-sectional view through the longitudinal axis 125 of the blind rivet nut 105. FIG. 3 shows that the blind rivet nut 105, while spun on the thread pin 155, has been completely incorporated in a clearance 201, in particular in a bore 201, of the workpiece 200. The blind rivet nut 105 by way of a contact face of the free axial portion 112 here bears on the detent face 170 of the mouthpiece 160. Once the blind rivet nut 105 has been completely incorporated in the bore 201, the lifting module generates a lifting movement which retracts the thread pin 155 into the mouthpiece 160. As a result, forces are exerted on the blind rivet nut 105 that lead to the closing bead 116 being generated and to the free axial portion 112 being outwardly enlarged in a manner so that the free axial portion 112 brings about a form-fit and/or friction-fit with the workpiece 200, in particular with the internal side of the clearance 201.

The corresponding deformations of the workpiece 200 and of the blind rivet nut 105 are illustrated enlarged in FIG. 4. The enlarged region is indicated by the dashed lines. FIG. 4 shows that an upper internal side 113 of the free axial portion 112, as a result of the force being exerted via the conical detent face 170, has generally been configured as a conical counterpart. This has the effect that an external surface 114 of the free axial portion 112 that faces away from the thread region 120 is also widened toward the outside, this being shown in FIG. 4 by a bending angle. These forces are likewise transmitted to the workpiece 200 so that an upper portion 202 of the workpiece 201 is again configured as a counterpart of the upper internal side 113 of the free axial portion 112. This has the consequence that the blind rivet nut 105 is henceforth fixed in both axial directions. Depending on how intense the corresponding deformations at the external surface 114 and the upper portion 202 are, this may be referred to as a form-fit or a friction-fit. In most cases, however, this would be a combination of a form-fit and a friction-fit.

The enlargement of the free axial portion 112 in the case of a conical contact face can also be described as follows. The free axial portion 112 in a state not impinged by a force has a radius R1, wherein the free axial portion 112 upon impingement by the force of the second force has a radius R2, where R1<R2.

As can be seen in FIGS. 3 and 4, the blind rivet nut 105 is incorporated in the workpiece 200 without an interfering edge on a smooth surface of the workpiece 200 being created.

It also applies to the exemplary embodiments hereunder that the technical effects and advantages which are described above in the context of the blind rivet nut also apply to the blind rivet stud.

FIG. 5 shows a lateral view of the assembly system 100b according to the present invention for setting a blind rivet stud 105b. A blind rivet stud setting tool 150b is not completely shown in the illustration according to FIG. 5 because a corresponding rotation module and lifting module associated with the blind rivet stud setting tool 150b are known to the person skilled in the art. Only those component parts of the blind rivet stud setting tool 150b that are relevant to the present invention, or advantageously refine the invention, are respectively shown.

Accordingly, the blind rivet stud setting tool 150b has an internal thread 152 onto which a screw 155b of the blind rivet stud can be driven. The screw 155b runs coaxially through a mouthpiece 160b. The screw 155b can be axially displaced through the mouthpiece 160b, in particular by the lifting module (which is not shown).

The mouthpiece 160b has a detent portion 165b, wherein the detent portion 165b has a detent face 170b. The detent face 170b by way of the larger face thereof faces the mouthpiece 160b, and by way of the smaller face thereof faces away from the mouthpiece 160b. The detent portion 165b in particular has a conical shape, the larger face thereof bearing on the mouthpiece 160b, or being able to be connected to the latter.

The blind rivet stud 105b in the lateral view displays the shape of a sleeve. The screw 155b can coaxially penetrate the blind rivet stud 105b and in particular have an external thread not shown in the lateral view.

The blind rivet stud 105b has a setting region 110b, a compression region 115b, and a screw region 120b. The setting region 110b, at least on the free axial portion 112b thereof facing the screw region 120b, when a second force acting on the setting region 110b is exceeded, in terms of the external dimension thereof, is able to be enlarged in the radial direction. To this end, the second force can in particular act in a radially outward manner. In principle, dimensions of the blind rivet stud 105b can be flexibly designed and accordingly be adapted so as to depend on the clearance of the workpiece 200. The compression region 115b is deformed so as to form a closing bead when the first force is being exerted. The screw 155b is fixed in the screw region 120b and can exert a corresponding force on the compression region 115b so that a closing bead is formed. The screw region 120b on the free end thereof has a conically tapered region 121. The conically tapered region 121 makes it possible that the blind rivet stud 105b can be more easily incorporated in a clearance of the workpiece 200. Self-centering of the blind rivet stud 105b in the clearance of the workpiece can be initiated by the conically tapered region 121. The compression region 115 should extend into the knurled region of the setting region to the extent of approximately ⅓.

Different shapes which the blind rivet stud 105b can assume include, for example, a round cross section or a hexagonal cross section. The external surface of the blind rivet stud 105b of the setting region 110 can have a fluting 111. The fluting 111 provides that the blind rivet stud 105b is secured in relation to the twisting in the clearance of the workpiece.

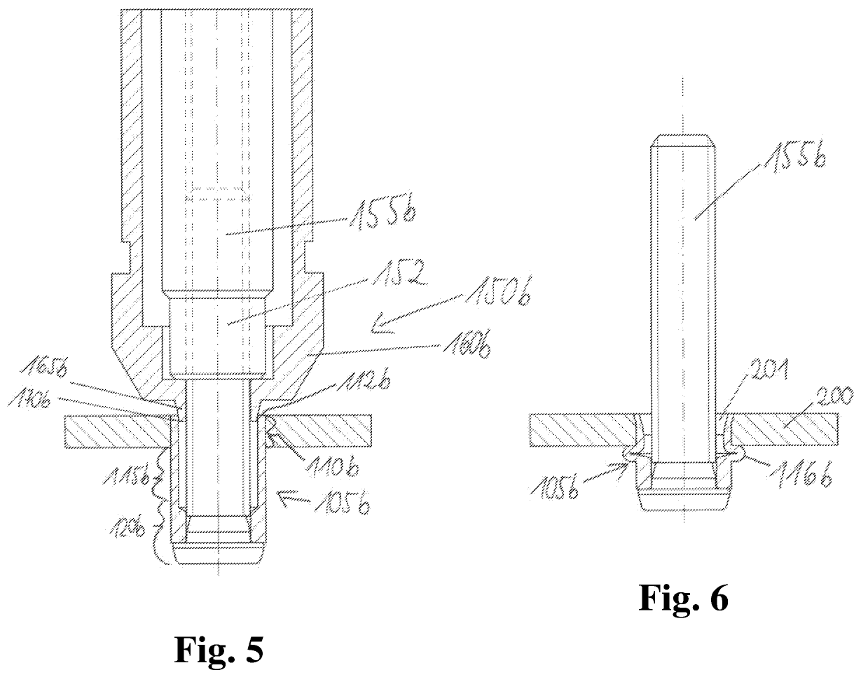

FIG. 6 shows the blind rivet stud 105b according to the present invention in a set state in the workpiece 200, as a cross-sectional view through the longitudinal axis 125 of the blind rivet stud 105b. FIG. 6 shows that the setting region 110b of the blind rivet stud 105b has been completely incorporated in the clearance, in particular in a bore 201, of the workpiece 200, with only the screw 155b projecting. A further workpiece can now, for example, be placed directly on the workpiece without any projection by virtue of this further workpiece likewise having a clearance through which the screw 155b is able to be guided. A nut can then be driven onto the screw 155b in order for both workpieces to be mutually braced.

Once the blind rivet stud 105b has been completely incorporated in the bore 201, and once the screw 155b has been spun on the internal thread 152, the lifting module generates a lifting movement which retracts the screw 155b into the mouthpiece 160b. As a result, forces are exerted on the blind rivet stud 105b that lead to the closing bead 116b being generated, and to the free axial portion 112 as a result of an interaction with the detent face 170b being outwardly enlarged in a manner so that the free axial portion 112 brings about a form-fit and/or friction-fit with the workpiece 200, in particular with the internal side of the clearance 201. At the end of this setting procedure, the blind rivet stud 105b is inserted in the workpiece 200 in a non-projecting manner at least on one side.

The features of the various aspects of the present invention described hereunder, or of the various exemplary embodiments, respectively, can be combined with one another unless this is explicitly precluded or is mandatorily precluded for technical reasons. The present invention is not limited to embodiments described herein; reference should be had to the appended claims.

### List of Reference Numerals

100 Assembly system
105 Blind rivet nut
105b Blind rivet stud
110 Setting region
110b Setting region
111 Fluting
112 Free axial portion
112b Free axial portion
113 Internal side
114 External surface
115 Compression region
115b Compression region
116 Closing bead
116b Closing bead
120 Thread region
120b Screw region
121 Conically tapered region
125 Longitudinal axis
150 Blind rivet nut setting tool
150b Blind rivet stud setting tool
152 Internal thread
155 Thread pin
155b Screw
160 Mouthpiece
160b Mouthpiece
165 Detent portion
165b Detent portion
170 Detent face
170b Detent face
200 Workpiece
201 Clearance/Bore
202 Upper portion

1-14. (canceled)

15. A blind rivet nut for incorporating a thread in a clearance of a workpiece and/or for connecting two workpieces, the blind rivet nut comprising:
a setting region;
a thread region which comprises an internal thread at least in portions of the thread region; and
a compression region arranged between the thread region and the setting region,
wherein,
the compression region is configured so that, when a first force acting on the compression region is exceeded, the compression region forms a closing bead,
the setting region comprises an axial portion which faces the compression region and a free axial portion which faces away from the compression region and from the thread region, and
the setting region, on the free axial portion which faces away from the thread region, is configured so that, with respect to an external dimension of the setting region, the setting region is enlarged at least in a radial direction when a second force acting on the setting region is exceeded.

16. The blind rivet nut as recited in claim 15, wherein the portion of the setting region that faces away from the thread region is substantially free of projections.

17. The blind rivet nut as recited in claim 15, wherein an external shape of the blind rivet nut has a cylindrical form, an outer form of the cylindrical form comprising a straight extent which is parallel to a rotation axis with respect to a longitudinal extent of the blind rivet nut.

18. The blind rivet nut as recited in claim 15, wherein the enlargement of the setting region in the radial direction is greater than 0.1% of the external dimension.

19. The blind rivet nut as recited in claim 15, wherein the first force is not equal to the second force.

20. The blind rivet nut as recited in claim 19, wherein the thread region is configured from a high-tensile material which is not deformed by the second force.

21. A blind rivet nut setting tool which is configured to set the blind rivet nut as recited in claim 15, the blind rivet nut setting tool comprising:
a thread pin comprising at least one thread portion, the thread pin being configured to have the blind rivet nut be spun thereon;
a mouthpiece which is arranged to surround the thread pin and which is configured to form a counter bearing for the blind rivet nut, the mouthpiece comprising a detent portion for the blind rivet nut, the detent portion comprising a detent face which decreases in size in a direction of the at least one thread portion;
a rotation module comprising a first operative connection to the thread pin, the rotation module being configured to transmit a rotating movement for at least one of spinning on and spinning off the blind rivet nut into the thread pin; and
a lifting module comprising a second operative connection to the thread pin, the lifting module being configured to transmit at least one lifting movement for compressing the blind river nut into the thread pin.

22. The blind rivet nut setting tool as recited in claim 21, wherein the detent face is enlarged continuously or via different angles.

23. The blind rivet nut setting tool as recited in claim 21, wherein the detent face is configured to be conical.

24. A method for setting a blind rivet nut in a clearance of a workpiece using a blind rivet nut setting tool, the method comprising:
providing a blind rivet nut setting tool comprising,
a thread pin comprising at least one thread portion, the thread pin being configured to have the blind rivet nut be spun thereon,
a mouthpiece which is arranged to surround the thread pin and which is configured to form a counter bearing for the blind rivet nut, the mouthpiece comprising a detent portion for the blind rivet nut, the detent portion comprising a detent face which decreases in size in a direction of the at least one thread portion,
a rotation module comprising a first operative connection to the thread pin, the rotation module being configured to transmit a rotating movement for at least one of spinning on and spinning off the blind rivet nut into the thread pin, and
a lifting module comprising a second operative connection to the thread pin, the lifting module being configured to transmit at least one lifting movement for compressing the blind river nut into the thread pin;
providing the blind rivet nut as recited in claim 15 on the thread pin of the blind rivet nut setting tool;
spinning on the blind rivet nut up to the detent face of the mouthpiece;
completely incorporating the free axial portion of the setting region of the blind rivet nut into the clearance of the workpiece; and
compressing the blind rivet nut via the at least one lifting movement of the blind rivet nut setting tool in a direction of the mouthpiece,
wherein,
the free axial portion of the setting region is enlarged via the at least one lifting movement so as to bring about at least one of a form-fit and a friction-fit with the workpiece, and
the compression region forms a closing bead.

25. An assembly system for setting a blind rivet nut, the assembly system comprising:
the blind rivet nut as recited in claim 15; and
a blind rivet nut setting tool which is configured to set the blind rivet nut as recited in claim 15, the blind rivet nut setting tool comprising:
a thread pin comprising at least one thread portion, the thread pin being configured to have the blind rivet nut be spun thereon,
a mouthpiece which is arranged to surround the thread pin and which is configured to form a counter bearing for the blind rivet nut, the mouthpiece comprising a detent portion for the blind rivet nut, the detent portion comprising a detent face which decreases in size in a direction of the at least one thread portion,
a rotation module comprising a first operative connection to the thread pin, the rotation module being configured to transmit a rotating movement for at least one of spinning on and spinning off the blind rivet nut into the thread pin, and
a lifting module comprising a second operative connection to the thread pin, the lifting module being configured to transmit at least one lifting movement for compressing the blind river nut into the thread pin,
wherein,
the assembly system is configured to perform a method comprising:
providing the blind rivet nut as recited in claim 15 on the thread pin of the blind rivet nut setting tool;
spinning on the blind rivet nut up to the detent face of the mouthpiece;
completely incorporating the free axial portion of the setting region of the blind rivet nut into the clearance of the workpiece; and
compressing the blind rivet nut via the at least one lifting movement of the blind rivet nut setting tool in a direction of the mouthpiece,
wherein,
the free axial portion of the setting region is enlarged via the at least one lifting movement so as to bring about at least one of a form-fit and a friction-fit with the workpiece, and
the compression region forms a closing bead.

26. A blind rivet stud for incorporating a thread in a clearance of a workpiece and/or for connecting two workpieces, the blind rivet stud comprising:
a setting region;
a screw region;
a screw comprising an external thread fixed in the screw region; and
a compression region arranged between the screw region and the setting region,
wherein,
the compression region is configured so that, when a first force acting on the compression region is exceeded, the compression region forms a closing bead,
the setting region comprises an axial portion which faces the compression region and a free axial portion which faces away from the compression region and from the screw region, and
the setting region, on the free axial portion which faces away from the screw region, is configured so that, with respect to an external dimension of the setting region, the setting region is enlarged at least in a radial direction when a second force acting on the setting region is exceeded.

27. The blind rivet stud as recited in claim 26, wherein the portion of the setting region that faces away from the screw region is substantially free of projections.

28. The blind rivet stud as recited in claim 26, wherein an external shape of the blind rivet stud has a cylindrical form, an outer form of the cylindrical form comprising a straight extent which is parallel to a rotation axis with respect to a longitudinal extent of the blind rivet stud.

29. The blind rivet stud as recited in claim 26, wherein the enlargement of the setting region in the radial direction is greater than 0.1% of the external dimension.

30. The blind rivet stud as recited in claim 26, wherein the first force is not equal to the second force.

31. The blind rivet stud as recited in claim 30, wherein the screw region is configured from a high-tensile material which is not deformed by the second force.

32. A blind rivet stud setting tool which is configured to set the blind rivet stud as recited in claim 26, the blind rivet stud setting tool comprising:
a mouthpiece which is configured to form a counter bearing for the blind rivet stud, the mouthpiece comprising an internal thread for spinning on the screw of the blind rivet stud; and a detent portion for the blind rivet stud, the detent portion comprising a detent face which decreases in size in a direction of the blind rivet stud that is able to be spun on;
a rotation module which is configured to transmit a rotation movement to the mouthpiece so as to at least one of spin on and spin off the blind rivet stud; and
a lifting module which is configured to transmit at least one lifting movement for compressing the blind rivet stud into the mouthpiece.

33. The blind rivet stud setting tool as recited in claim 32, wherein the detent face is enlarged continuously or via different angles.

34. The blind rivet stud setting tool as recited in claim 32, wherein the detent face is configured to be conical.

35. A method for setting a blind rivet stud in a clearance of a workpiece using a blind rivet stud setting tool, the method comprising:
providing a blind rivet stud setting tool which is configured to set the blind rivet stud as recited in claim 26, the blind rivet stud setting tool comprising,
a mouthpiece which is configured to form a counter bearing for the blind rivet stud, the mouthpiece comprising an internal thread for spinning on the screw of the blind rivet stud, and a detent portion for the blind rivet stud, the detent portion comprising a detent face which decreases in size in a direction of the blind rivet stud that is able to be spun on,
a rotation module which is configured to transmit a rotation movement to the mouthpiece so as to at least one of spin on and spin off the blind rivet stud, and
a lifting module which is configured to transmit at least one lifting movement for compressing the blind rivet stud into the mouthpiece;
spinning on the blind rivet stud as recited in claim 26 up to the detent face of the mouthpiece;
completely incorporating the free axial portion of the setting region of the blind rivet stud into the clearance of the workpiece; and
compressing the blind rivet stud via the at least one lifting movement of the blind rivet stud setting tool in a direction counter to the clearance,
wherein,
the free axial portion of the setting region is enlarged via the at least one lifting movement so as to bring about at least one of a form-fit and a friction-fit with the workpiece, and
the compression region forms a closing bead.

36. An assembly system for setting a blind rivet stud, the assembly system comprising:
the blind rivet stud as recited in claim 26; and
a blind rivet stud setting tool which is configured to set the blind rivet stud as recited in claim 26, the blind rivet stud setting tool comprising,
a mouthpiece which is configured to form a counter bearing for the blind rivet stud, the mouthpiece comprising an internal thread for spinning on the screw of the blind rivet stud, and a detent portion for the blind rivet stud, the detent portion comprising a detent face which decreases in size in a direction of the blind rivet stud that is able to be spun on,
a rotation module which is configured to transmit a rotation movement to the mouthpiece so as to at least one of spin on and spin off the blind rivet stud, and
a lifting module which is configured to transmit at least one lifting movement for compressing the blind rivet stud into the mouthpiece,
wherein,
the assembly system is configured to perform a method comprising:
spinning on the blind rivet stud as recited in claim 26 up to the detent face of the mouthpiece;
completely incorporating the free axial portion of the setting region of the blind rivet stud into the clearance of the workpiece; and
compressing the blind rivet stud via the at least one lifting movement of the blind rivet stud setting tool in a direction counter to the clearance,
wherein,
the free axial portion of the setting region is enlarged via the at least one lifting movement so as to bring about at least one of a form-fit and a friction-fit with the workpiece, and
the compression region forms a closing bead.
